(19) United States
(12) Patent Application Publication
(10) Pub. No.: US 2013/0298378 A1
(43) Pub. Date: Nov. 14, 2013

(54) MOUNTING SYSTEM FOR WATER CARTRIDGE AND MANIFOLD

(71) Applicant: Ramesh Suri, Vancouver (CA)

(72) Inventor: Ramesh Suri, Vancouver (CA)

(21) Appl. No.: 13/717,345

(22) Filed: Dec. 17, 2012

Related U.S. Application Data
(60) Provisional application No. 61/576,214, filed on Dec. 15, 2011.

(51) Int. Cl. B01D 27/08

(52) U.S. Cl. CPC B01D 27/08
USPC 29/428; 210/236

(57) ABSTRACT

A filter has a mounting system that includes a variety of projections. In one embodiment, the filter has two projections, each having the same height and cross-section. In another embodiment, the filter has two or more projections, with at least two of the projections having different heights, shapes, dimensions, locations and/or cross-sections.

### CROSS-REFERENCES TO RELATED APPLICATIONS

This application claims priority from U.S. Application No. 61/576,214, filed Dec. 15, 2011 incorporated by reference in its entirety.

### BACKGROUND OF THE INVENTION

Many refrigerators include a mechanism to dispense drinking water. Before the water is dispensed, it flows through a replaceable filter cartridge to remove impurities. The cartridge is removably mounted to the refrigerator and has a limited life, such that the cartridge must be periodically replaced in order to maintain efficacy.

U.S. Pat. No. 6,949,189, which is incorporated by reference herein, describes a rotary valve assembly including a head portion that is configured for communication with an inlet conduit and an outlet port that is connected with an outlet conduit. A pair of diametrically opposed inclined cam lugs project outwardly from a neck portion and are dimensioned and configured to facilitate rotational engagement of the filter cartridge with an intermediate support flange depending from a mounting bracket. The support flange includes an aperture and a pair of diametrically opposed cam ramps projecting radially into a central aperture for interacting with the inclined lower surfaces of the cam lugs.

Referring to FIG. 5 of the '189 patent, lugs 62 and 64 are adapted for reception with a pair of corresponding diametrically opposed reception areas 102 and 104 formed in the interior cavity of the valve member 26. The device is described as having a unique key formation with a plurality of spaced-apart axially projecting teeth adapted and configured to engage and mate with a corresponding set of spaced recesses. In FIGS. 3-9 of the '189 patent, for example, the key formation on each lug 62 and 64 includes three spaced-apart teeth 62a, 62c, 64a and 64c, and each reception area 102 and 104 within the valve member includes three corresponding recesses 102a-102c-104a-104c (see FIGS. 6-9 of the '189 patent).

With reference to FIG. 11 of the '189 patent, the neck portion 46 of the cartridge is inserted and, upon rotating the cartridge 40 in conjunction with the valve member 26, the cam lug 62 and 64 projecting from the neck portion 46 translate against the ramps 72 and 74 (FIG. 2 of the '189 patent) to cause the filter to move helically upwardly in an axial direction to rotate the valve into the “on position” with the inlets and outlets aligned through the filter assembly.

This system, however, is intended to block connection with a filter without the appropriate keyed construction for the lug. That is, the consumer wishing to replace an expired filter cartridge must use a cartridge with a pre-determined key combination in order for the filter to mount onto the head.

There is a need in the art for an improved cartridge filter mounting system in which an expired filter cartridge having any of a variety of different specific key combinations may be replaced with a filter cartridge that may have any of a variety of projections in terms of shape, height, spacing and/or other characteristics.

### BRIEF DESCRIPTION OF THE DRAWINGS

FIG. 1 illustrates a mounting cap for a filter cartridge;

FIG. 2 illustrates views of the mounting cap of FIG. 1 mounted on a filter;

FIG. 3 illustrates an exploded view of the filter of FIG. 1 and a part to which it mounts, to secure the filter to the refrigerator;

FIG. 4 illustrates the filter of FIG. 2 mounted in the refrigerator;

FIG. 5 illustrates the flow of water through a filter cartridge of FIG. 4 when mounted on a refrigerator;

FIG. 6A is a side view of a mounting cap according to the present invention;

FIG. 6B is a first cross-sectional view of the mounting cap of FIG. 6A;

FIG. 6C is a second cross-sectional view of the mounting cap of FIG. 6A;

FIG. 6D is a detail view of the area encircled in FIG. 6A;

FIG. 6E is a top view of the mounting cap of FIG. 6A;

FIG. 6F is a perspective view of the mounting cap of FIG. 6A;

FIG. 7A is a detail cross-sectional view of one embodiment of a mounting cap according to the present invention;

FIG. 7B is a detail cross-sectional view of another aspect of the embodiment of FIG. 7A;

FIG. 7C is a top view of the embodiment of FIG. 7A;

FIG. 7D is a further detail view of the embodiment of FIG. 7A;

FIG. 7E is a further cross-sectional view of the embodiment of FIG. 7A;

FIG. 8 illustrates an alternative embodiment in which two posts of circular cross-section and two posts of rectangular cross-section are employed;

FIG. 9 illustrates an alternative embodiment in which two posts having oval configuration are employed;

FIG. 10 illustrates an alternative embodiment in which two posts having a circular cross-section are employed;

FIGS. 11-13 are side views showing posts extending from the filter, in which the posts may have any desired height, even with different heights on each post as desired.

### DETAILED DESCRIPTION OF A PREFERRED EMBODIMENT

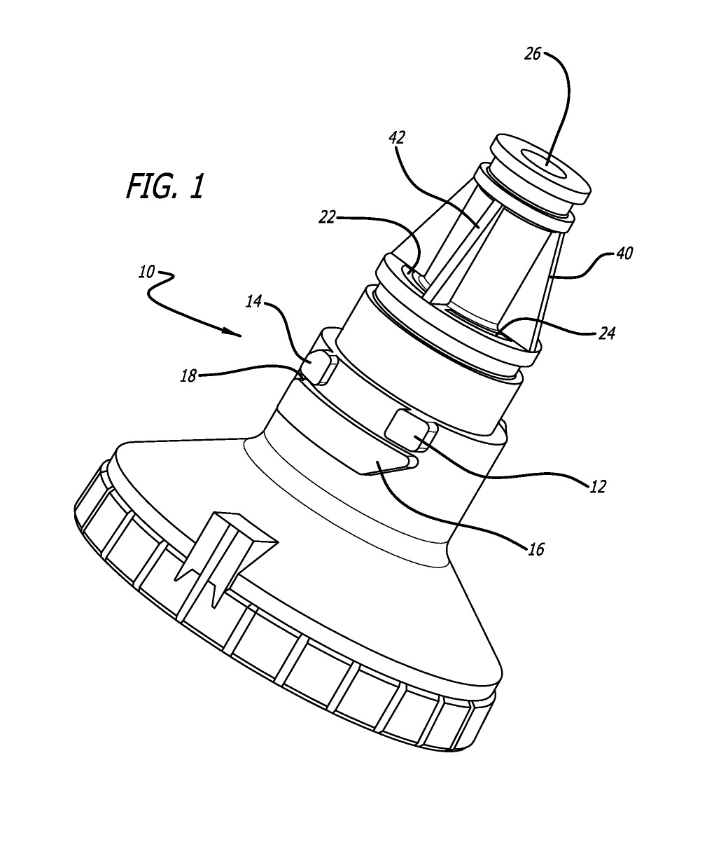

FIG. 1 illustrates a mounting cap 10 for a water filter having two square dots 12 and 14, a locking support 16, and a locking slot 18 in between the dots and the locking support. The dots in the preferred embodiment are square, but could alternatively be round, triangular or another shape. The mounting cap 10 is typically molded, such as a molded polymer, and the “dots” and “locking support” are, in a preferred embodiment, molded projections from a surface of the mounted cap.

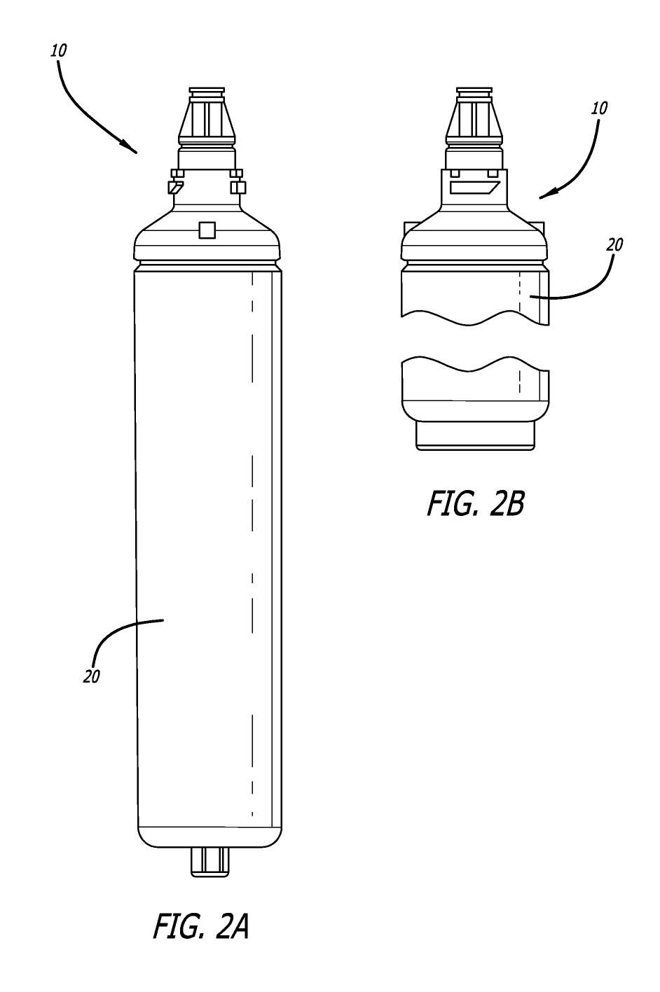

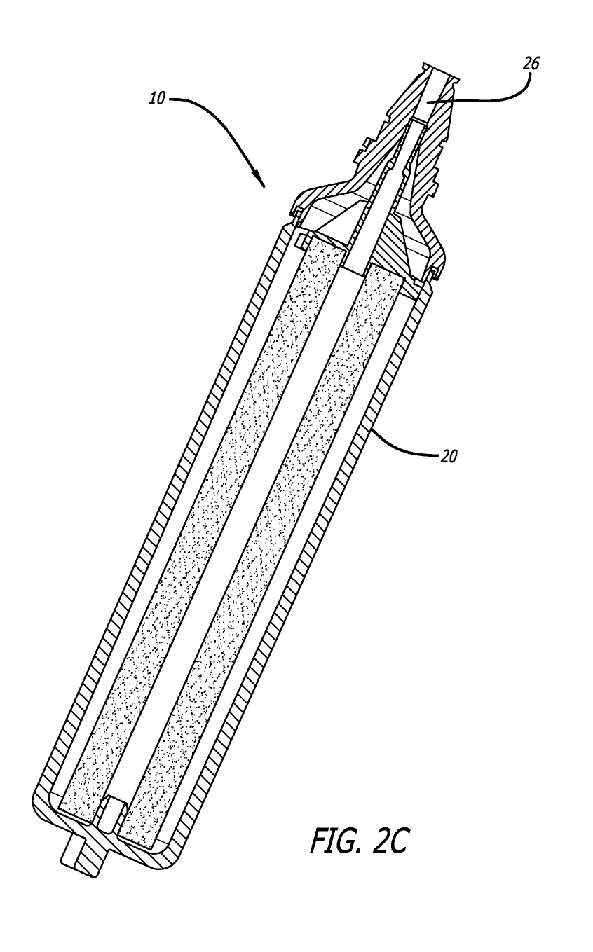

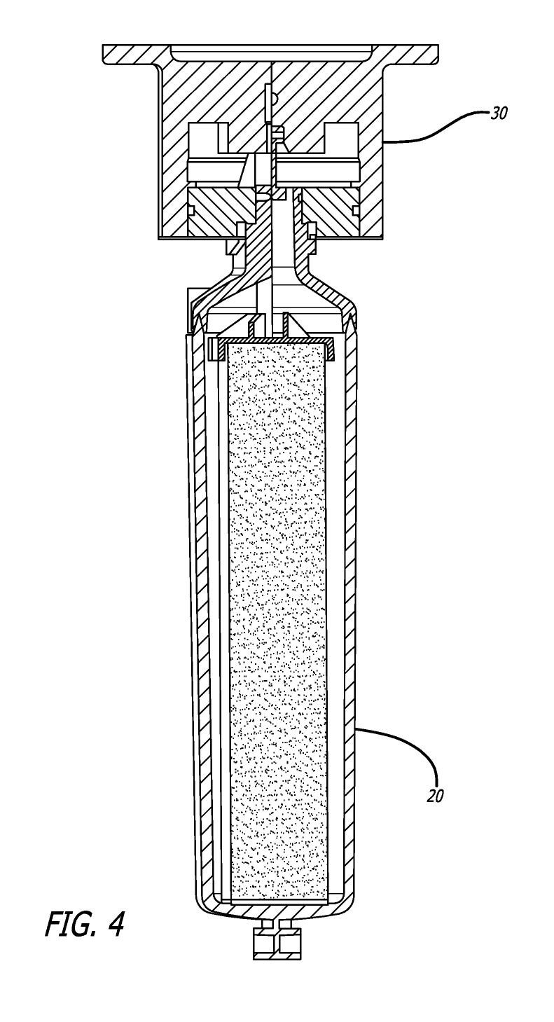

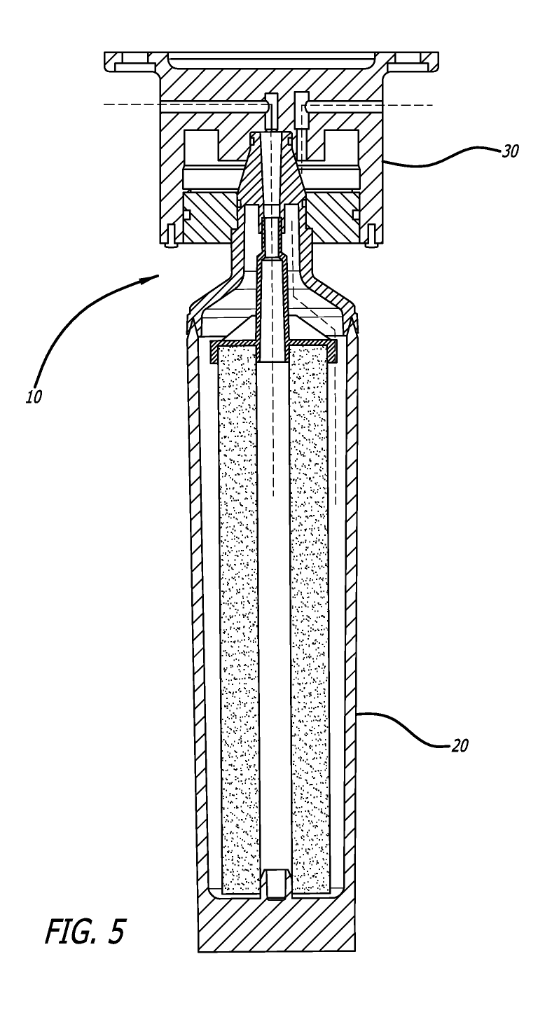

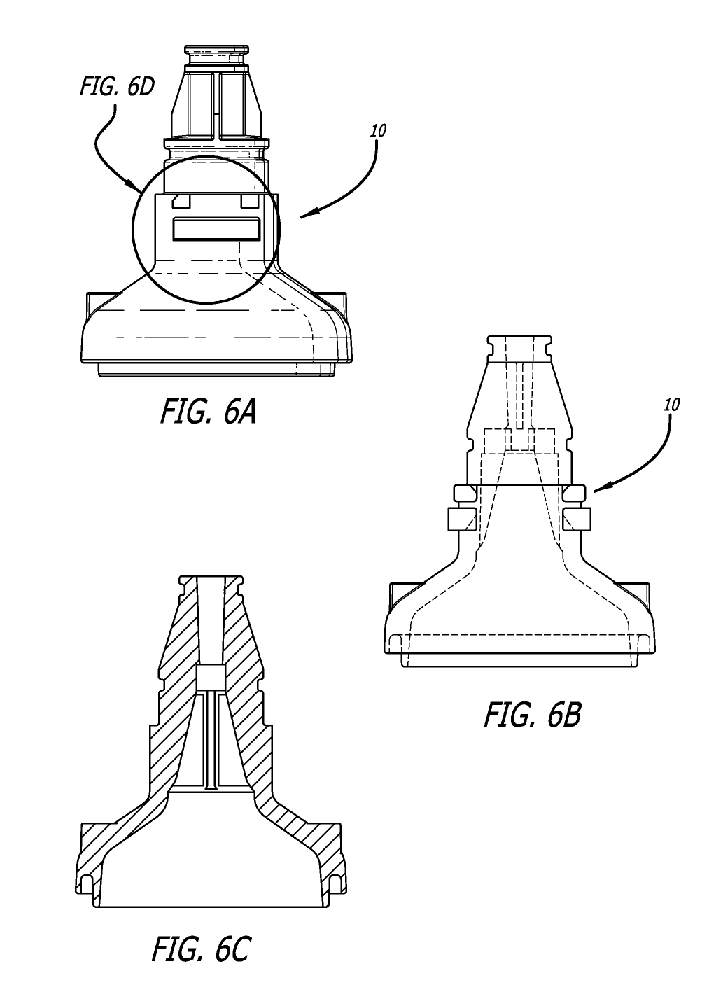

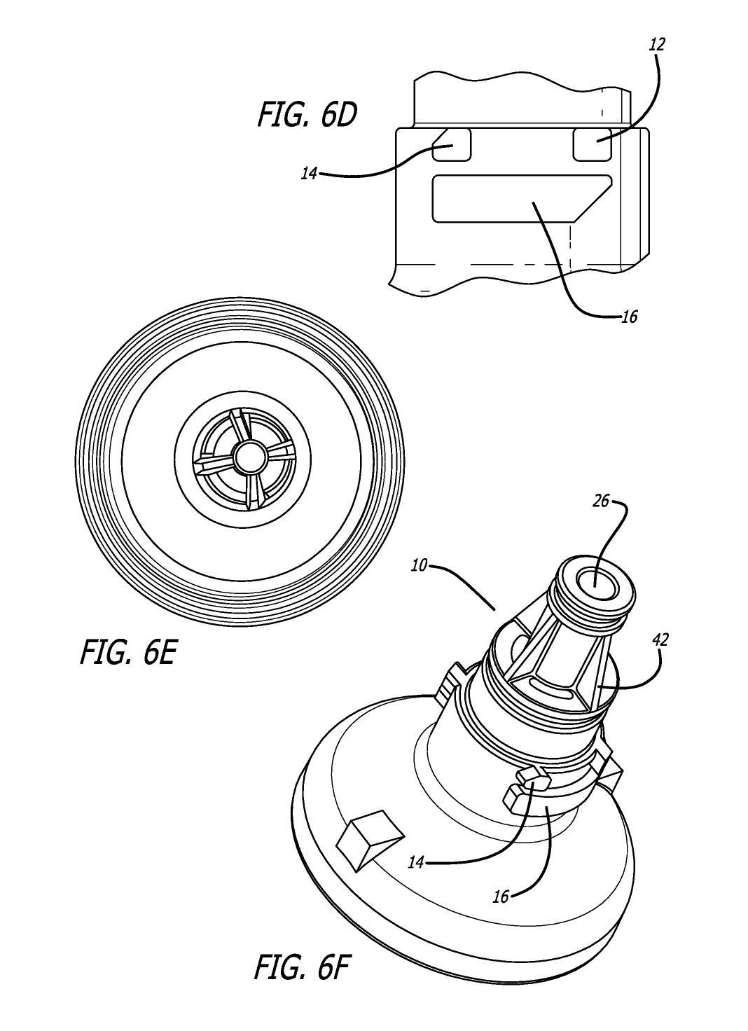

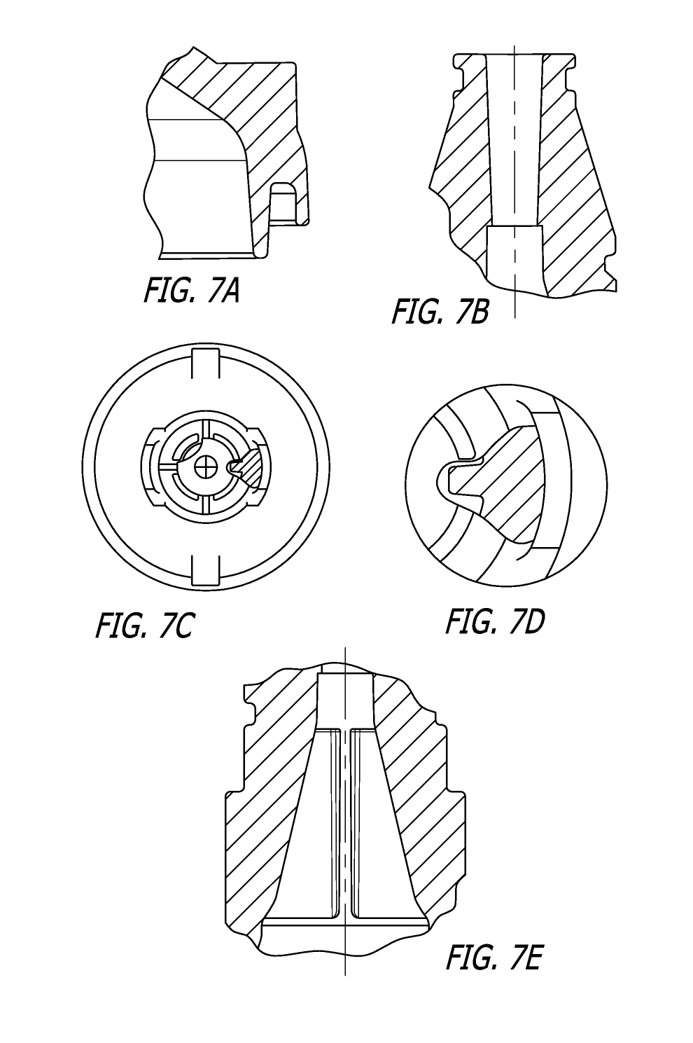

FIG. 2 illustrates the mounting cap 10 of FIG. 1 as mounted on a water filter 20. Water flows into inlet ports such as 22, 24 (FIG. 1) around an upper perimeter of the filter, and then flows out through a central bore 26 extending through the center of the mounting cap. The filter as mounted in the refrigerator appears in FIG. 4, and the water in/water out flow of water is illustrated in FIG. 5.

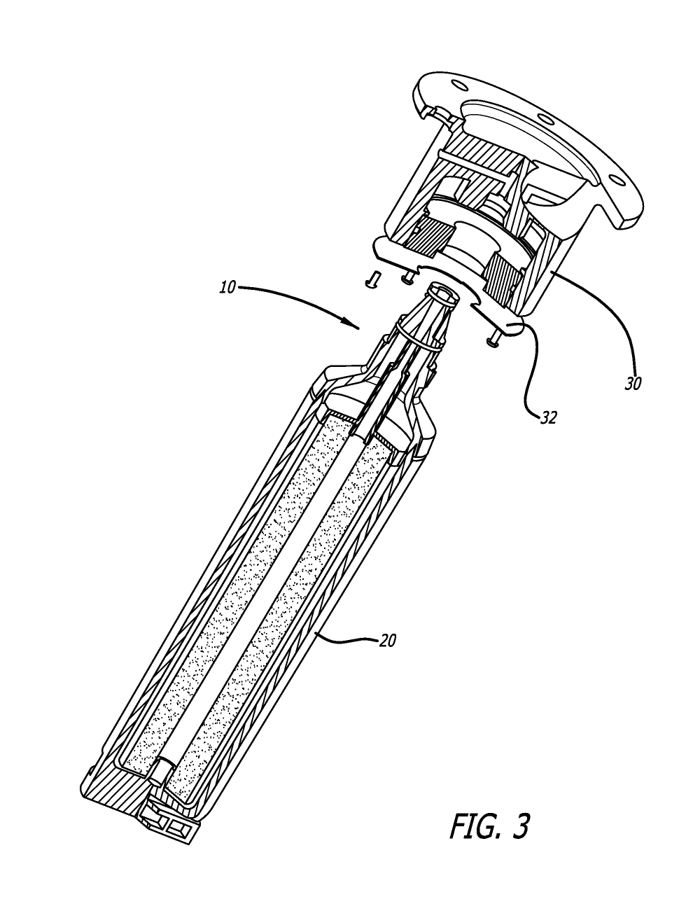

Considering further FIG. 3, to mount the filter, it is pushed up into the mounting part. Openings in the mounting part are provided to allow the dots on the filter to push up through the opening to the mounting part 30. Once the dots are above the locking plate 32 (FIG. 3), the user rotates the filter so as to engage the locking plate in the locking slot, in between the square dots and the locking support on the filter mounting cap. The filter is then mounted in place in the refrigerator (FIGS. 4 and 5).

More generally, referring to the attached Figures, the filter is intended to mount to a mounting part 30 depicted in FIG. 3. The mounting part is formed with a downwardly facing central cavity for receiving the neck of a filter body. Received in the cavity is a position bushing formed with a central bore configured with stepped diameters to receive the neck of the filter body and is configured in its lower extremity with an enlarged in diameter, downwardly opening gland. Affixed to the bottom of the mounting part, underlying the bushing, is an annular locking plate formed with a central bore of a predetermined diameter to receive the neck and formed in its diametrically opposite sides with annular clearance notches (FIGS. 3 and 4).

The filter neck is configured with a central bore 26 for outflow of filtered water and is configured in its exterior periphery with diametrically outwardly projecting annular ribs such as 40, 42 identified as locking supports. The locking supports terminate on their respective ends in sloping surfaces. Formed on the neck above the locking supports are respective raised, radially outwardly projecting, square dots 12, 14 spaced above the respective locking supports 16 a distance to accommodate the thickness of the locking plate.

Thus, when it is desirable to change filter bodies, the filter body itself 20 may be grasped and rotated relative to the mounting part 30 to position the square dots 12, 14 over the respective clearance notches to release the filter body to be moved axially downwardly. When a new filter then is to be placed in position or the same filter body reattached, the neck of the filter body may be inserted upwardly in the bore of the positioning bushing and the respective pairs of square dots aligned below the respective annular clearance notches to pass axially upwardly through the notches to an elevation above the top surface of the locking plate, and then the filter body rotated to rotate the neck to orbit the respective square dots out of alignment with the respective clearance slots to trap the marginal edge of the bore in the locking plate between the respective locking supports square dots to attach the filter in position. The square dots are not intended to serve as a keying element to limit attachment of a filter body to any particular type of OEM equipment or mounting part and are configured to allow the filter body to be attached to different styles of mounts.

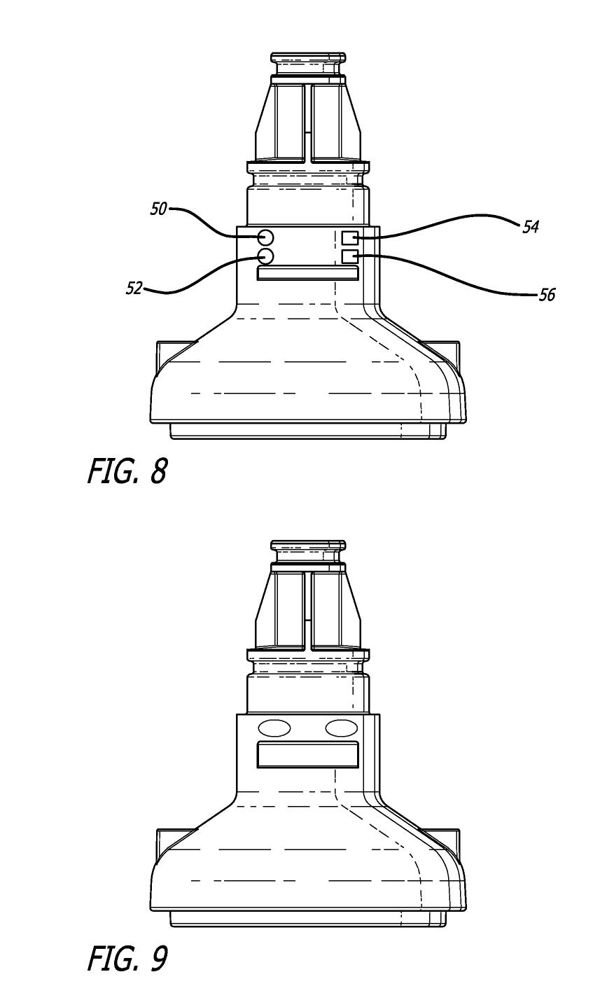

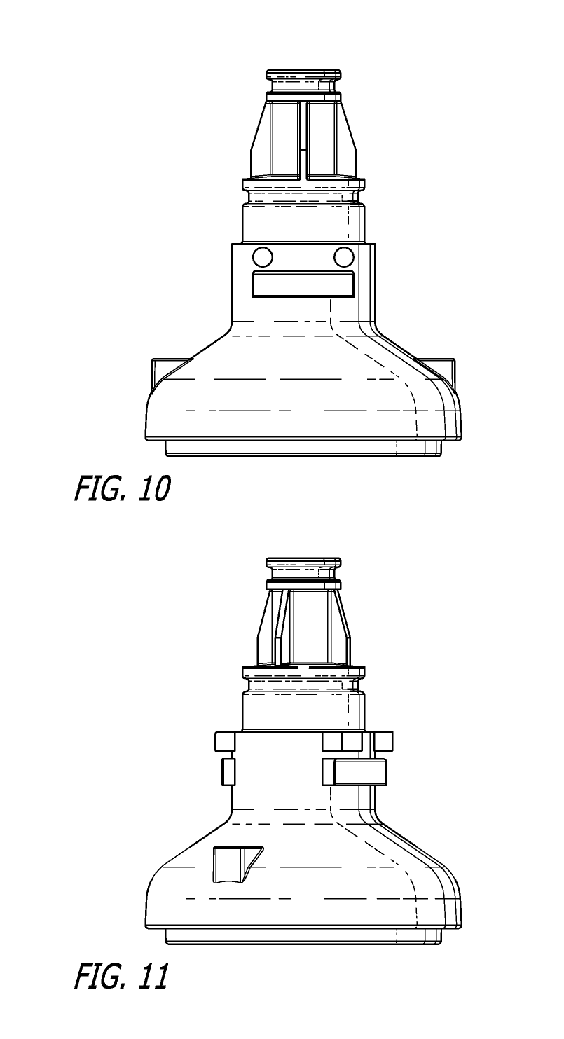

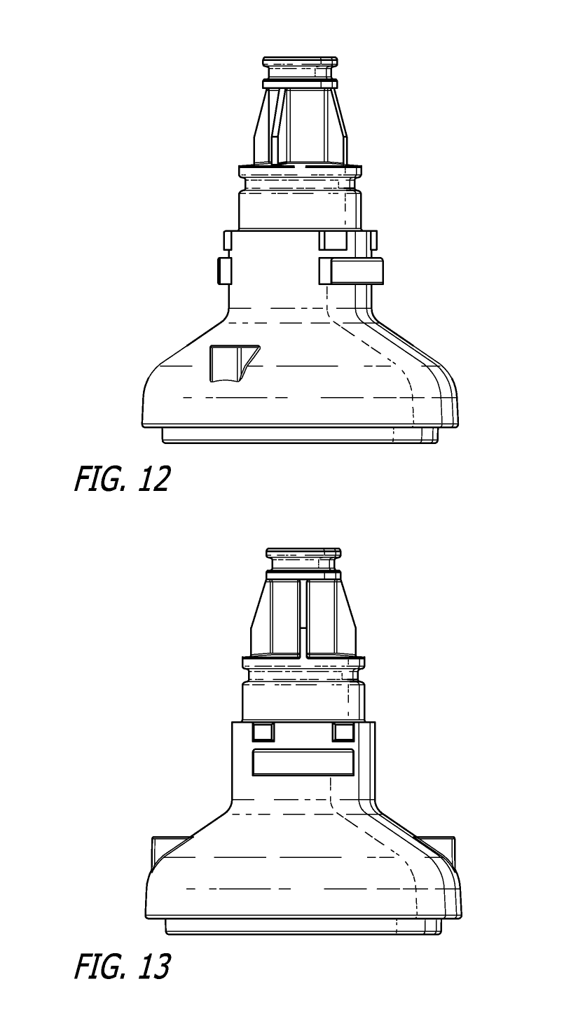

As illustrated in FIGS. 8-13, the filters may have any of a variety of combinations of shapes, numbers, and heights of dots. The dots may be circular in cross-section, rectangular, triangular, oval or any other combination or variety of shapes. In FIG. 8, for example, each of the circular cross-section protrusions or dots 50, 52 may have a unique height. Each of the rectangular cross-sectioned protrusions may have a unique height, all depending of the manifold to which the filter is to mate. While FIG. 8 illustrates two circular 50, 52 and two rectangular protrusions 54, 56, there may be three or more circular protrusions, and/or three or more rectangular protrusions, or any combination thereof. Similarly, the shapes may be mixed on each side with, for example, two circular posts and a rectangular post on one side and two rectangular posts and a circular post on the other, with each post having a unique height, or any combination of heights desired.

FIGS. 9-13 illustrate further embodiments and features.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention, and that particular embodiments of the invention may have additional advantages. Therefore, it is to be understood that the invention may be practiced other than as specifically described herein.

1. A filter having a proximal mounting portion and a distal end portion, comprising:
at least one dot protruding from the proximal mounting portion;
a locking support;
a locking slot in between the at least one dot and the locking support.

2. A filter as defined in claim 1, wherein the at least one dot is one of square, round, triangle, and oval cross-section.

3. A filter as defined in claim 1, wherein the filter comprises first and second dots protruding from the proximal mounting portion, the locking slot extending between the locking support and the first and second dots.

4. A filter as defined in claim 3, wherein the dots each have a unique height.

5. A filter as defined in claim 1, wherein each dot has at least one of a unique shape and a unique cross-section.

6. A filter as defined in claim 1, wherein there are a plurality of dots in at least one of different shapes, heights, locations, pairings.

7. A method of mounting the filter of claim 1 to a mounting part having a locking plate, the filter having a tip and the method of claim 1 comprising the steps of:
pushing a tip of the filter through an opening in the mounting part until the at least one dot engages with a portion of the mounting part, such that the locking slot is aligned with the locking plate; and
rotating the filter to engage the locking slot with the mounting plate, thereby securing the filter to the mounting part.

8. The method of claim 7, wherein the filter is a water filter and method is a method of mounting the filter to a refrigerator.

9. The filter of claim 3, wherein the proximal mounting portion comprises the protruding dots, a plurality of fins, a central bore with an opening at a tip of the proximal mounting portion, and at least one inlet port on an upper perimeter of the filter.

10. A filter having a proximal mounting portion and a distal end portion, the filter comprising:
first and second dots protruding from the proximal mounting portion;
a locking support;
a locking slot extending between the locking support and the first and second dots;
wherein the proximal mounting portion further comprises a plurality of fins, a central water outflow bore having an opening, and a plurality of water inlet ports around an upper perimeter of the filter;
wherein at least one of the dots has a cross-section that is generally one of square, rectangular, round, triangular, and oval.
